(19) United States
(12) Patent Application Publication
(10) Pub. No.: US 2015/0029148 A1
(43) Pub. Date: Jan. 29, 2015

(54) CAPACITIVE IN-CELL TOUCH SCREEN PANEL AND DISPLAY DEVICE

(71) Applicants: BEIJING BOE OPTOELECTRONICS TECHNOLOGY CO., LTD, Beijing (CN); BOE TECHNOLOGY GROUP CO., LTD., Beijing (CN)

(72) Inventors: Chunlei Wang, Beijing (CN); Xue Dong, Beijing (CN); Chuncheng Che, Beijing (CN); Hailin Xue, Beijing (CN); Haisheng Wang, Beijing (CN); Lei Wang, Beijing (CN); Jianyun Xie, Beijing (CN); Shengji Yang, Beijing (CN); Weijie Zhao, Beijing (CN)

(21) Appl. No.: 14/344,226

(22) PCT Filed: May 16, 2013
(86) PCT No.: PCT/CN2013/075724

§ 371 Date: Mar. 11, 2014

(30) Foreign Application Priority Data
Mar. 28, 2013 (CN) 201310103385

(51) Int. Cl. G06F 3/044

(52) U.S. Cl. CPC G06F 3/044
USPC 345/174

(57) ABSTRACT

The present disclosure relates to a capacitive in-cell touch screen panel and a display device in which first touch detecting electrodes and second touch detecting electrodes insulated with each other are provided on a substrate; the first touch detecting electrodes are located between the substrate and the black matrix, the second touch detecting electrodes are located on a side of the black matrix away from the substrate. Because the first touch detecting electrodes and the second touch detecting electrodes are provided on the substrate away from the TFT array substrate, it is possible to avoid mutual interference between touch signals and display signals in the TFT array substrate, thereby not only ensuring the quality of pictures on a liquid crystal display but also enhancing reliability of touch operations.

### TECHNICAL FIELD

The present disclosure relates to a capacitive in-cell touch screen panel and a display device.

### BACKGROUND

With the fast development of display technology, touch screen panels have gradually become popular in people's life. At present, based on the constituting structures, touch screen panels can be classified into add-on mode touch screen panels, on-cell touch screen panels, and in-cell touch screen panels. For add-on mode touch screen panels, the touch screen panel and the liquid crystal display are produced separately and then attached together to form a liquid crystal display with touch function, which suffer disadvantages such as high manufacturing costs, low light transmission ratio, and great thickness of modules. For in-cell touch screen panels, touch electrodes of the touch screen panel are embedded inside the liquid crystal display, which can reduce the overall thickness of the module and also greatly decrease manufacturing costs of touch screen panels, winning attractiveness from panel manufacturers.

At present, conventional capacitive in-cell touch screen panels are implemented by directly adding touch scanning lines and touch sensing lines on conventional TFT (Thin Film Transistor) array substrates, that is, manufacturing two layers of strip electrodes intersecting with each other in different planes on the surface of the TFT array substrate. These two layers of electrodes serve as touch driving lines and touch sensing lines of the touch screen panel respectively and mutual capacitors are formed at intersections between the two electrodes in the different planes. Its working process is as follows: upon applying touch driving signals to electrodes serving as touch driving lines, voltage signals are coupled out by touch sensing lines via mutual capacitors and are detected; during this process, where a human body touches the touch screen panel, the human electric field acts on the capacitors to change the capacitance values and then change the voltage signals coupled out by touch sensing lines, and therefore the location of the touch point can be determined depending on variation of the voltage signals.

With the above-mentioned structure design of a capacitive in-cell touch screen panel, touch signals applied to touch scanning lines and touch sensing lines added in a conventional TFT array substrate would interfere with original display signals in the TFT array substrate, which both influences the quality of pictures displayed on the liquid crystal display and degrades reliability of touch operation.

### SUMMARY

Embodiments of the present invention provide a capacitive in-cell touch screen panel and a display device that can address mutual interference between display signals and touch signals in prior art in-cell touch screen panels.

A capacitive in-cell touch screen panel provided in an embodiment of the present invention includes a substrate and a black matrix provided on the substrate, and further includes first touch detecting electrodes between the substrate and the black matrix, and second touch detecting electrodes on a side of the black matrix away from the substrate.

Furthermore, the black matrix has opening regions arranged in matrix;

The first touch detecting electrodes extend in a row direction of the opening regions, the second touch detecting electrodes extend in a column direction of the opening regions; or the second touch detecting electrodes extend in a row direction of the opening regions, the first touch detecting electrodes extend in a column direction of the opening regions.

Furthermore, a material for the first touch detecting electrodes is a metal material or a transparent conducting material; a material for the second touch detecting electrodes is a metal material or a transparent conducting material.

Furthermore, a material for the first touch detecting electrodes is a metal material, and orthogonal projections of the first touch detecting electrodes on the substrate is inside an orthogonal projection of the black matrix;

A material for the second touch detecting electrodes is a metal material, and orthogonal projections of the second touch detecting electrodes on the substrate is inside an orthogonal projection of the black matrix.

Furthermore, a material for the first touch detecting electrodes is a transparent conducting material, and the first touch detecting electrodes are of a diamond shaped electrode structure;

A material for the second touch detecting electrodes is a transparent conducting material, and the second touch detecting electrodes are of a diamond shaped electrode structure.

Furthermore, the first touch detecting electrodes and/or the second touch detecting electrodes comprise inward contracting structures at overlapping positions between the first touch detecting electrodes and the second touch detecting electrodes.

Furthermore, a material for the first touch detecting electrodes is a transparent conducting material;

In a display time interval, the first touch detecting electrodes are grounded;

In a touch time interval, the first touch detecting electrodes couple touch scanning signals applied by the second touch detecting electrodes and output results.

Furthermore, a material for the second touch detecting electrodes is a transparent conducting material, and the second touch detecting electrodes constitute a common electrode layer;

In a display time interval, the second touch detecting electrodes are applied with common electrode signals;

In a touch time interval, the second touch detecting electrodes are applied with touch scanning signals.

Furthermore, a material for the first touch detecting electrodes is a transparent conducting material;

In a display time interval, the first touch detecting electrodes are grounded;

In a touch time interval, the first touch detecting electrodes are applied with touch scanning signals.

Furthermore, a material for the second touch detecting electrodes is a transparent conducting material, and the second touch detecting electrodes constitute a common electrode layer;

In a display time interval, the second touch detecting electrodes are applied with common electrode signals;

In a touch time interval, the second touch detecting electrodes couple the touch scanning signals and output results.

A display device provided in an embodiment of the present invention includes the capacitive in-cell touch screen panel provided in embodiments of the present invention.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a structural representation of a capacitive in-cell touch screen panel provided in embodiments of the present invention;

FIG. 2 is a structural representation of a substrate provided in embodiments of the present invention;

FIG. 3 is illustrative structural representation I between first touch detecting electrodes and second touch detecting electrodes provided in embodiments of the present invention;

FIG. 4 is illustrative structural representation II between first touch detecting electrodes and second touch detecting electrodes provided in embodiments of the present invention; and

FIG. 5 is a schematic diagram of leads in the touch screen panel provided in embodiments of the present invention.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Specific implementations of the capacitive in-cell touch screen panel and the display device provided in embodiments of the present invention will be described in detail below with reference to accompanying drawings.

Thicknesses and shapes of the film layers in the drawings do not reflect the real proportion or scale and only function to illustrate embodiments of the present invention.

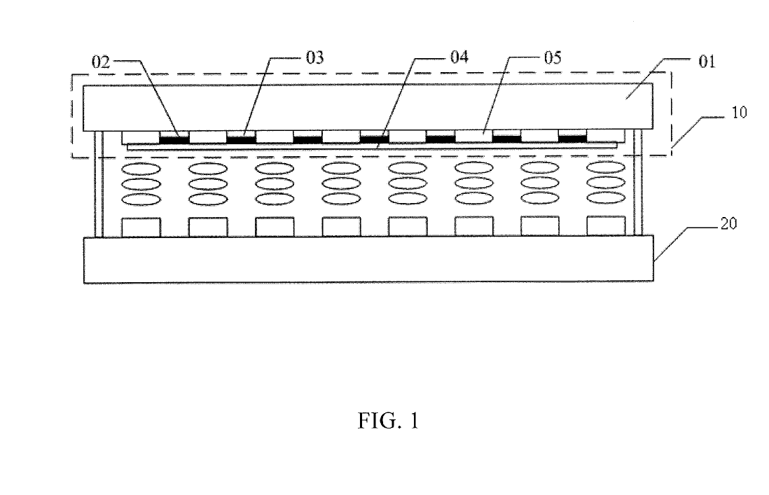

As shown in FIG. 1, a capacitive in-cell touch screen panel provided in an embodiment of the present invention includes a substrate 01 and a black matrix 02 provided on the substrate 01, and further includes first touch detecting electrodes 03 between the substrate 01 and the black matrix 02, and second touch detecting electrodes 04 on a side of the black matrix 02 away from the substrate 01.

In practice, the first touch detecting electrodes 03 may be touch sensing electrodes (Receive, Rx), and the second touch detecting electrodes 04 are touch driving electrodes (Transport, Tx) correspondingly. On the contrary, the first touch detecting electrodes 03 may be touch driving electrodes Tx, and the second touch detecting electrodes 04 are touch sensing electrodes Rx correspondingly, which is not limited herein.

Further, as shown in FIG. 1, the above-mentioned touch screen panel provided in the embodiment of the present invention may be applied to a structure in which color filters 05 are provided on a substrate opposite to the TFT array substrate 20 (namely a color filter substrate 10), or may be applied to a structure in which the color filters are provided in the TFT array substrate, which is not limited herein.

With the above-mentioned capacitive in-cell touch screen panel provided in an embodiment of the present invention, because the first touch detecting electrodes 03 or the second touch detecting electrodes 04 serving as touch driving electrodes Tx are provided on the color filter substrate 10 away from the TFT array substrate 20; in the case where the touch driving electrodes Tx apply touch scanning signals, it is possible to reduce interference of touch scanning signals on the display signals applied on the TFT array substrate 20 such as gate scanning signals and gray scale signals, ensuring the quality of display pictures of the touch screen panel. And because the first touch detecting electrodes 03 or the second touch detecting electrodes 04 serving as touch sensing electrodes Rx are also provided on the color filter substrate 10 away from the TFT array substrate 20; in the case the touch sensing electrodes Rx couple the touch scanning signals, it is possible to reduce interference of display signals applied on the TFT array substrate 20 on electrical signals coupled by the touch sensing electrodes Rx, hence improving reliability of touch operations.

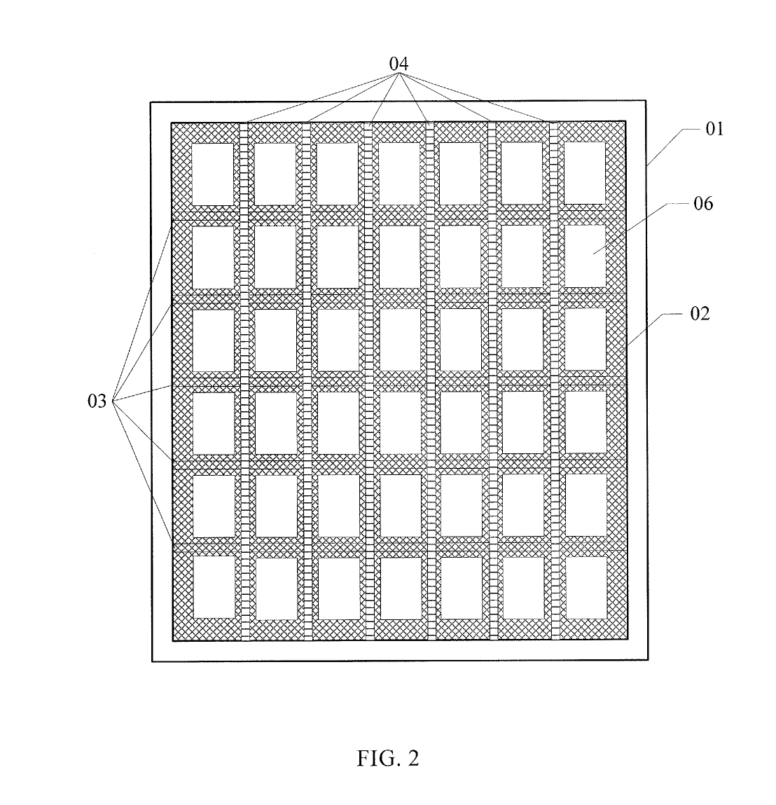

Particularly, in the above-mentioned touch screen panel provided in the embodiment of the present invention, as shown in FIG. 2, the black matrix 02 formed on the substrate 01 generally comprises opening regions 06 arranged in matrix, which openings correspond to the effective display regions of the pixel units in the TFT array substrate. In practice, as shown in FIG. 2, the first touch detecting electrodes 03 formed on the substrate 01 may extend in a row direction of the opening regions 06, and the second touch detecting electrodes 04 may extend in a column direction of the opening regions 06, that is, the first touch detecting electrodes 03 provided on the substrate 01 are consistent with gate signal lines in the TFT array substrate in terms of routing direction, and the second touch detecting electrodes 04 provided on the substrate 01 are consistent with the data signal lines in the TFT array substrate in terms of routing direction. Or, the first touch detecting electrodes formed on the substrate may extend in a column direction of the opening regions, and the second touch detecting electrodes may extend in a row direction of the opening regions, that is, the second touch detecting electrodes provided on the substrate are consistent with the gate signal lines in the TFT array substrate in terms of routing direction, and the first touch detecting electrodes provided on the substrate are consistent with the data signal lines in the TFT array substrate in terms of routing direction. Of course, the first touch detecting electrodes and the second touch detecting electrodes provided on the substrate may also extend in other directions, which is not limited herein.

Description will be given below with an example in which the first touch detecting electrodes extend in a row direction of opening regions, and the second touch detecting electrodes extend in a column direction of opening regions.

In practice, the first touch detecting electrodes may be made of a metal material or a transparent conducting material, and in a similar way, the second touch detecting electrodes may also be made of a metal material or a transparent conducting material.

Particularly, when the first touch detecting electrodes 03 are made of a metal material, due to the opaque property of metal, the first touch detecting electrodes 03 are generally provided at locations shielded by the black matrix 02, as shown in FIG. 2, that is, the orthogonal projections of the first touch detecting electrodes 03 on the substrate 01 is located within the orthogonal projection of the black matrix 02 to prevent the first touch detecting electrodes 03 made of metal from influencing aperture ratio of the pixel units. Further, when the first touch detecting electrodes 03 made of a metal material serve as touch driving electrodes Tx, since the resistance of the first touch detecting electrodes 03 is small, it is possible to effectively reduce the time delay of the touch driving electrodes Tx transferring touch scanning signals (Loading).

Similarly, as shown in FIG. 2, when the second touch detecting electrodes 04 are made of a metal material, the second touch detecting electrodes 04 are generally provided at locations shielded by the black matrix 02, that is, the orthogonal projections of the second touch detecting electrodes 04 on the substrate is located within the orthogonal projection of the black matrix 02 to prevent the second touch detecting electrodes 04 made of metal from influencing aperture ratio of the pixel units.

Where both the first touch detecting electrodes 03 and the second touch detecting electrodes 04 are made of a metal materials, the black matrix 02 between the first touch detecting electrodes 03 and the second touch detecting electrodes 04 serves as an insulating layer for them to avoid shorting therebetween. In practice, the black matrix may be made of a material of a small dielectric constant to reduce capacitance value between the first touch detecting electrodes 03 and the second touch detecting electrodes 04, hence improving the touch sensitivity.

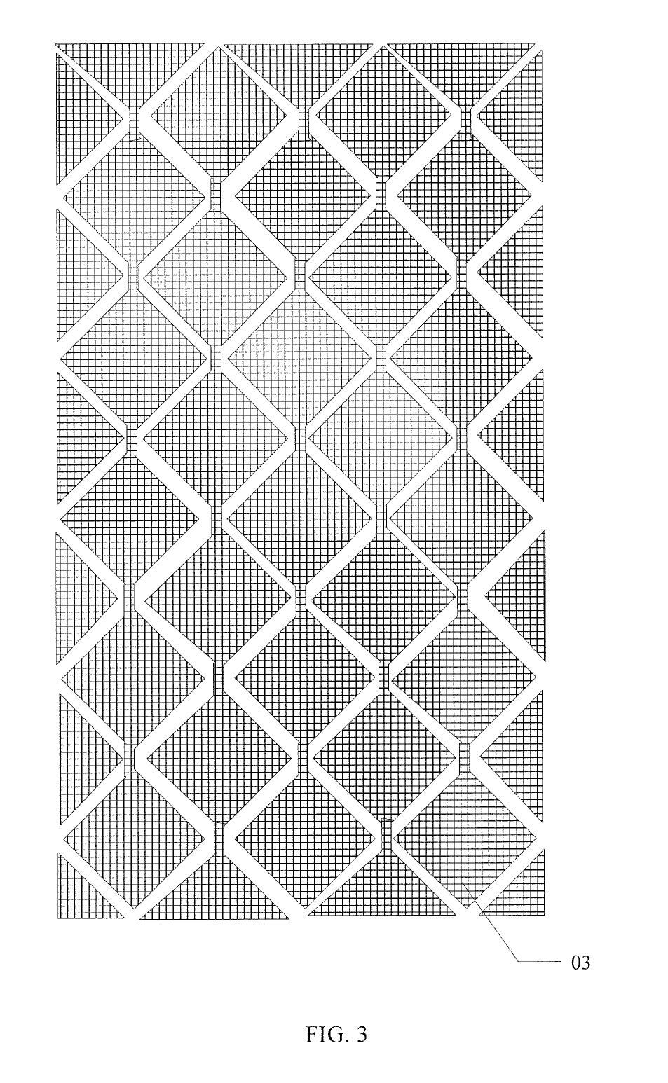

Furthermore, since the first touch detecting electrodes 03 are located between the substrate and the black matrix, after assembling the color filter substrate and the TFT array substrate together to form a cell, the first touch detecting electrodes 03 are relatively closer to the viewer; if the first touch detecting electrodes 03 are made of metal, normal display of the touch screen panel may be impacted due to the light reflection from the metal material. Therefore, in practice, the first touch detecting electrodes 03 may be made of a transparent conductor material such as indium tin oxide (ITO). When the first touch detecting electrodes 03 are made of a transparent conducting material, the first touch detecting electrodes 03 may be of a diamond shaped electrode structure as shown in FIG. 3.

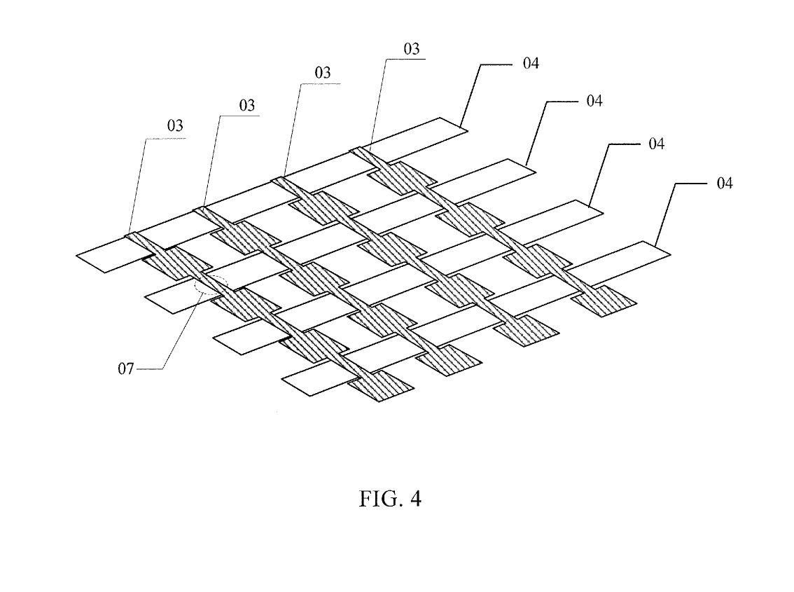

Furthermore, when the first touch detecting electrodes 03 are of a strip electrode structure or diamond shaped electrode structure, inward contracting structures may be further provided at overlapping positions between the first touch detecting electrodes 03 and the second touch detecting electrodes 04 to reduce overlapping areas between the first touch detecting electrodes 03 and the second touch detecting electrodes 04, and hence reducing node capacitance generated at the overlapping positions and improving touch sensitivity. As shown in FIG. 4, the first touch detecting electrodes 03 and the second touch detecting electrodes 04 are of a strip electrode structure, inward contracting structures 07 are provided at the overlapping positions between the first touch detecting electrodes 03 and the second touch detecting electrodes 04, and the width of the first touch detecting electrodes 03 at the inward contracting structures 07 is smaller than the width of the first touch detecting electrodes 03 at positions not overlapping with the second touch detecting electrodes 04.

Furthermore, when the second touch detecting electrodes 04 are made of a transparent conducting material, the second touch detecting electrodes 04 may also be set in a diamond shaped electrode structure. In a similar way, in order to reduce node capacitance generated at the overlapping positions between the second touch detecting electrodes 04 and the first touch detecting electrodes 03, it is also possible to provide inward contracting structures at the overlapping positions between the second touch detecting electrodes 04 and the first touch detecting electrodes 03 to improve touch sensitivity.

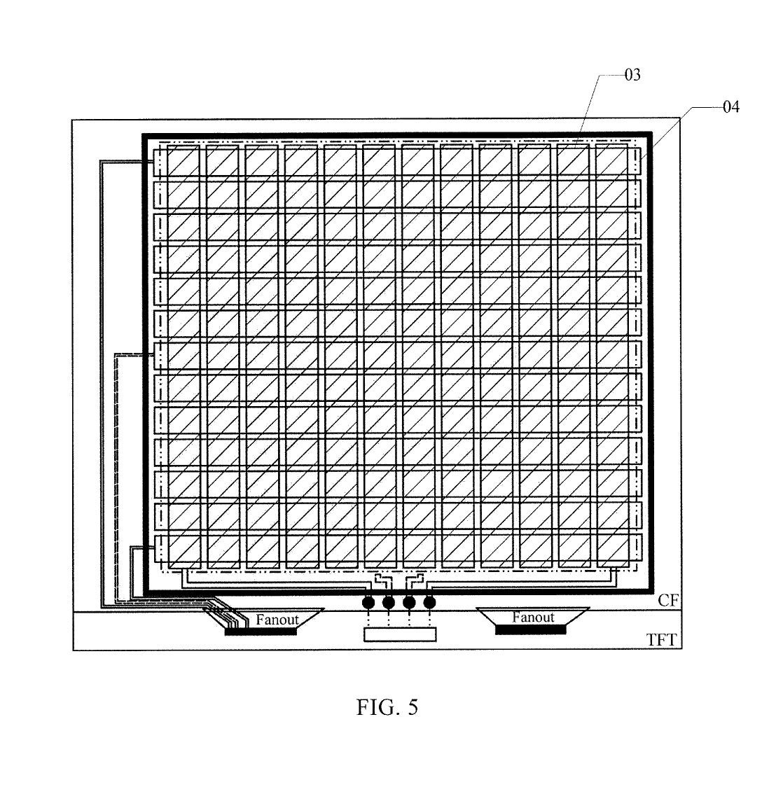

In general, the touch precision of a touch screen panel is on the order of millimeter, while the precision of liquid crystal display is generally on the order of micron, and therefore, it is possible to combine a plurality of adjacent second touch detecting electrodes as one second touch detecting electrode. In practice, it is possible to conduct a plurality of adjacent second touch detecting electrodes one another via a metal wire to serve as one second touch detecting electrode according to the required touch precision. Similarly, it is possible to conduct a plurality of adjacent first touch detecting electrodes one another via a metal wire to serve as one first touch detecting electrode according to the required touch precision. Further, as shown in FIG. 5 (only part of leads are shown), each of the first touch detecting electrodes 03 on the substrate is conducted with the TFT array substrate via a lead and conductive adhesive (TR) and finally connected with an IC chip; and each of the second touch detecting electrodes 04 is connected with a touch flexible printed circuit (Touch FPC) via the fan-out of the substrate and conductive adhesive (TR).

In practice, the first touch detecting electrodes in the touch screen panel provided in an embodiment of the present invention may also realize the function of shielding electrodes in a multiplex way. Firstly, the time period for the touch screen panel to display every frame (V-sync) is divided into a display time interval (Display) and a touch time interval (Touch). For example, the time period for the touch screen panel to display one frame is 16.7 millisecond (ms), in which 5 ms are used for the touch time interval and the remaining 11.7 ms for display time interval. Of course it is possible to appropriately adjust durations of the both time intervals depending on the processing capacity of IC chips, which is not limited herein.

Where the material for the first touch detecting electrodes is a transparent conducting material, in the display time interval, the first touch detecting electrodes may be grounded and act as shielding electrodes to prevent external electrostatic interference on normal display of the touch screen panel; in the touch time interval, if the first touch detecting electrodes are used as touch sensing electrodes, the first touch detecting electrodes couple the touch scanning signals applied by the second touch detecting electrodes and output the results; if the first sensing electrodes are used as touch driving electrodes, the first touch detecting electrodes apply touch scanning signals.

Particularly, the above-mentioned touch screen panel provided in the embodiments of the present invention may be applied to various modes of liquid crystal display panels, such as in-plane switch (IPS) and advanced super dimension switch (ADS) liquid crystal display panels that can realize wide viewing angle, and also applied to conventional twisted nematic (TN) liquid crystal display panels, which is not limited herein. In manufacturing the above-mentioned touch screen panel provided in the embodiments of the present invention by using a TN-type liquid crystal display panel, the common electrode layer in the color filter substrate may be omitted, and with time-division driving, the second touch detecting electrodes made of a transparent conducting material can be used as the common electrode layer in a multiplex manner.

If the second touch detecting electrodes are used as touch sensing electrodes, in the display time interval, the second touch detecting electrodes are applied with common electrode signals, and at this time the second touch detecting electrodes serve as common electrodes to form electric fields with pixel electrodes on the TFT array substrate for controlling orientation of liquid crystal. In the touch time interval, the second touch detecting electrodes couple touch scanning signals and output results.

If the second touch detecting electrodes are used as touch driving electrodes, in the display time interval, the second touch detecting electrodes are applied with common electrode signals, and at this time the second touch detecting electrodes serve as common electrodes to form electric fields with pixel electrodes on the TFT array substrate for controlling orientation of liquid crystal. In the touch time interval, the second touch detecting electrodes are applied with touch scanning signals.

From the same inventive concept, an embodiment of the present invention further provides a display device including the above-mentioned capacitive in-cell touch screen panel provided in any of the embodiments of the present invention. The embodiments of the above-mentioned capacitive in-cell touch screen panel may be referred to for implementations of the display device and repeated contents will not be described any more.

With the capacitive in-cell touch screen panel and the display device provided in the embodiments of the present invention, first touch detecting electrodes and second touch detecting electrodes insulated with each other are provided on a substrate; the first touch detecting electrodes are located between the substrate and the black matrix, the second touch detecting electrodes are located on a side of the black matrix away from the substrate. Because the first touch detecting electrodes and the second touch detecting electrodes are provided on the substrate away from the TFT array substrate, it is possible to avoid mutual interference between touch signals and display signals in the TFT array substrate, thereby not only ensuring the quality of pictures on a liquid crystal display but also enhancing reliability of touch operations.

It is to be understood that one skilled in the art can made various variations and modifications to the present invention without departing from the spirit and scope of the present invention. Thus, if these modifications and variations of the present invention fall within the scope of claims and equivalents of the present invention, it is intended that the present invention also encompass these modifications and variations.

1. A capacitive in-cell touch screen panel comprising: a substrate, a black matrix provided on the substrate, first touch detecting electrodes located between the substrate and the black matrix, and second touch detecting electrodes located a side of the black matrix away from the substrate.

2. The touch screen panel of claim 1, wherein the black matrix has opening regions arranged in matrix;
the first touch detecting electrodes extend in a row direction of the opening regions, the second touch detecting electrodes extend in a column direction of the opening regions; or
the second touch detecting electrodes extend in a row direction of the opening regions, the first touch detecting electrodes extend in a column direction of the opening regions.

3. The touch screen panel of claim 1, wherein a material for the first touch detecting electrodes is a metal material or a transparent conducting material; a material for the second touch detecting electrodes is a metal material or a transparent conducting material.

4. The touch screen panel of claim 1, wherein a material for the first touch detecting electrodes is a metal material, and orthogonal projections of the first touch detecting electrodes on the substrate is inside an orthogonal projection of the black matrix;
a material for the second touch detecting electrodes is a metal material, and orthogonal projections of the second touch detecting electrodes on the substrate is inside an orthogonal projection of the black matrix.

5. The touch screen panel of claim 1, wherein a material for the first touch detecting electrodes is a transparent conducting material, and the first touch detecting electrodes are of a diamond shaped electrode structure; and
a material for the second touch detecting electrodes is a transparent conducting material, and the second touch detecting electrodes are of a diamond shaped electrode structure.

6. The touch screen panel of claim 1, wherein the first touch detecting electrodes and/or the second touch detecting electrodes comprise inward contracting structures at overlapping positions between the first touch detecting electrodes and the second touch detecting electrodes.

7. The touch screen panel of claim 1, wherein a material for the first touch detecting electrodes is a transparent conducting material;
in a display time interval, the first touch detecting electrodes are grounded; and
in a touch time interval, the first touch detecting electrodes couple touch scanning signals applied by the second touch detecting electrodes and output results.

8. The touch screen panel of claim 7, wherein a material for the second touch detecting electrodes is a transparent conducting material, and the second touch detecting electrodes constitute a common electrode layer;
in a display time interval, the second touch detecting electrodes are applied with common electrode signals; and
in a touch time interval, the second touch detecting electrodes are applied with touch scanning signals.

9. The touch screen panel of claim 1, wherein a material for the first touch detecting electrodes is a transparent conducting material;
in a display time interval, the first touch detecting electrodes are grounded; and
in a touch time interval, the first touch detecting electrodes are applied with touch scanning signals.

10. The touch screen panel of claim 9, wherein a material for the second touch detecting electrodes is a transparent conducting material, and the second touch detecting electrodes constitute a common electrode layer;
in a display time interval, the second touch detecting electrodes are applied with common electrode signals; and
in a touch time interval, the second touch detecting electrodes couple the touch scanning signals and output results.

11. A display device comprising the capacitive in-cell touch screen panel according to claim 1.

12. The touch screen panel of claim 2, wherein the first touch detecting electrodes and/or the second touch detecting electrodes comprise inward contracting structures at overlapping positions between the first touch detecting electrodes and the second touch detecting electrodes.

13. The touch screen panel of claim 2, wherein a material for the first touch detecting electrodes is a transparent conducting material;
in a display time interval, the first touch detecting electrodes are grounded; and
in a touch time interval, the first touch detecting electrodes couple touch scanning signals applied by the second touch detecting electrodes and output results.

14. The touch screen panel of claim 13, wherein a material for the second touch detecting electrodes is a transparent conducting material, and the second touch detecting electrodes constitute a common electrode layer;
in a display time interval, the second touch detecting electrodes are applied with common electrode signals; and
in a touch time interval, the second touch detecting electrodes are applied with touch scanning signals.

15. The touch screen panel of claim 2, wherein a material for the first touch detecting electrodes is a transparent conducting material;
in a display time interval, the first touch detecting electrodes are grounded; and
in a touch time interval, the first touch detecting electrodes are applied with touch scanning signals.

16. The touch screen panel of claim 15, wherein a material for the second touch detecting electrodes is a transparent conducting material, and the second touch detecting electrodes constitute a common electrode layer;
in a display time interval, the second touch detecting electrodes are applied with common electrode signals; and
in a touch time interval, the second touch detecting electrodes couple the touch scanning signals and output results.

17. The touch screen panel of claim 5, wherein a material for the first touch detecting electrodes is a transparent conducting material;
in a display time interval, the first touch detecting electrodes are grounded; and
in a touch time interval, the first touch detecting electrodes couple touch scanning signals applied by the second touch detecting electrodes and output results.

18. The touch screen panel of claim 17, wherein a material for the second touch detecting electrodes is a transparent conducting material, and the second touch detecting electrodes constitute a common electrode layer;
in a display time interval, the second touch detecting electrodes are applied with common electrode signals; and
in a touch time interval, the second touch detecting electrodes are applied with touch scanning signals.

19. The touch screen panel of claim 5, wherein a material for the first touch detecting electrodes is a transparent conducting material;
in a display time interval, the first touch detecting electrodes are grounded; and
in a touch time interval, the first touch detecting electrodes are applied with touch scanning signals.

20. The touch screen panel of claim 19, wherein a material for the second touch detecting electrodes is a transparent conducting material, and the second touch detecting electrodes constitute a common electrode layer;
in a display time interval, the second touch detecting electrodes are applied with common electrode signals; and
in a touch time interval, the second touch detecting electrodes couple the touch scanning signals and output results.
